(19) United States
(12) Patent Application Publication
(10) Pub. No.: US 2015/0028160 A1
(43) Pub. Date: Jan. 29, 2015

(54) WINGTIP FOR A GENERAL AVIATION AIRCRAFT

(71) Applicant: John Gregory Roncz, Elkhart, IN (US)

(72) Inventor: John Gregory Roncz, Elkhart, IN (US)

(21) Appl. No.: 14/293,160

(22) Filed: Jun. 2, 2014

Related U.S. Application Data
(60) Provisional application No. 61/830,089, filed on Jun. 1, 2013.

(51) Int. Cl. B64C 23/06; B64C 3/00

(52) U.S. Cl. CPC B64C 23/065; B64C 3/00
USPC 244/199.4

(57) ABSTRACT

A wingtip for extending a wing of an aircraft having a NACA 23012 airfoil. The wingtip has an airfoil design for directing and associated wingtip vortex outward and upward to thereby increase the effective wingspan of the aircraft and to reduce induced drag. The wingtip is preferably molded and comprises a fuel tank bay, internal antenna, landing light and navigation light.

### FIELD OF THE INVENTION

The present invention relates to wing tips for general aviation aircraft. More particularly, the present invention relates to a wing tip particularly designed for a Beechcraft Bonanza type aircraft.

### BACKGROUND OF THE INVENTION

General aviation aircraft are a class of airplanes comprising business and personal aircraft which are not military or airline transport aircraft. One of the most popular types of general aviation aircraft is a Beechcraft Bonanza type aircraft, in particular a Bonanza or Baron model aircraft. The production of these aircraft started in 1947 and many are still flying today. Although several different models have been made over the years reflecting new and improved technology, the models still use the same airfoil: NACA 23012.

Although the airfoil of the models does not represent recently developed technology, bonanzas are well known for their aerodynamic efficiency and good performance. However, there remains room for improvement, particularly with respect to wingtip design.

In accordance with the present invention, an add-on or replacement wingtip is provided which is particularly well-suited for installation on Beechcraft bonanza or Baron aircraft, hereinafter collectively referred to as Bonanza aircraft. Installation of a wingtip of the present invention on a Bonanza aircraft provides additional lift while lowering the induced drag of the Bonanza wing and the overall total drag of the wing. Furthermore the wingtip of the present invention is capable of holding approximately one hour of additional fuel thus providing extended range to the aircraft. Still further the wingtip of the present invention is designed with additional dihedral which improves the spiraling stability of the Bonanza aircraft. As a result of adding wingtips of the present invention to Bonanza aircraft, the aircraft obtains an improved climb rate while enjoying lower spiraling moment, longer range and a higher true airspeed.

It will be appreciated by those skilled in the art that a preferred embodiment of the present invention is disclosed herein as a wingtip for Bonanza aircraft. However, the present invention can be adapted for use on other similar type general aviation aircraft having the same or similar airfoil wing. Such other similar type general aviation aircraft are intended to be included within the broad scope of the present invention.

Further understanding of the present invention will be had from the following specification and claims taken in conjunction with the accompanying drawings.

### BRIEF DESCRIPTION OF THE DRAWINGS

FIG. 1 is a perspective view of an embodiment of a left wingtip of the present invention;

FIG. 2 is a top plan view of a right wingtip which is a mirror image of the preferred embodiment of FIG. 1;

FIG. 3 is a side elevation view of the wingtip of FIG. 2;

FIG. 4 is a front elevation view of the wingtip of FIG. 1; and

FIG. 5 is a somewhat schematic view illustrating the pressure pattern obtained by the preferred embodiment of the wingtip of FIGS. 1.

### SUMMARY OF THE INVENTION

A wingtip for extending a wing of an aircraft incorporates a series of airfoils intended to direct the associated wingtip vortex outward and upward to thereby increase the effective wingspan of the aircraft and to reduce induced drag. The wingtip is preferably molded from composite materials, carbon fiber and/or fiberglass, and comprises a fuel tank bay, internal antenna, landing light and navigation light.

### DESCRIPTION OF THE INVENTION

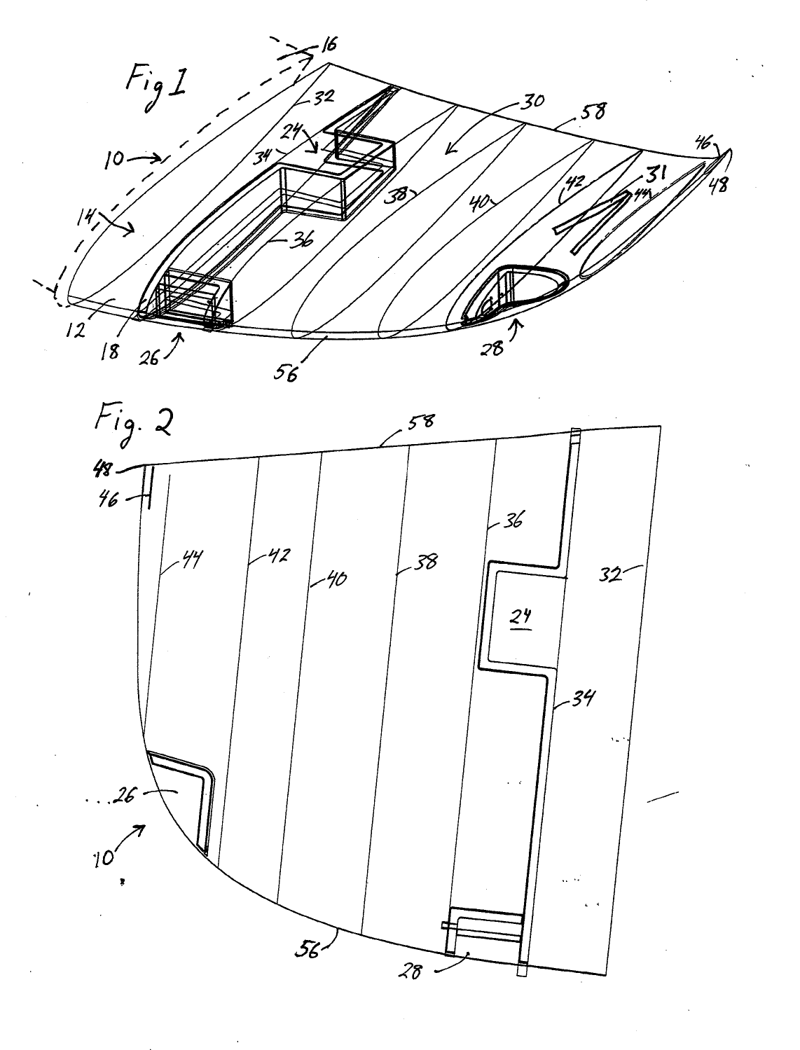

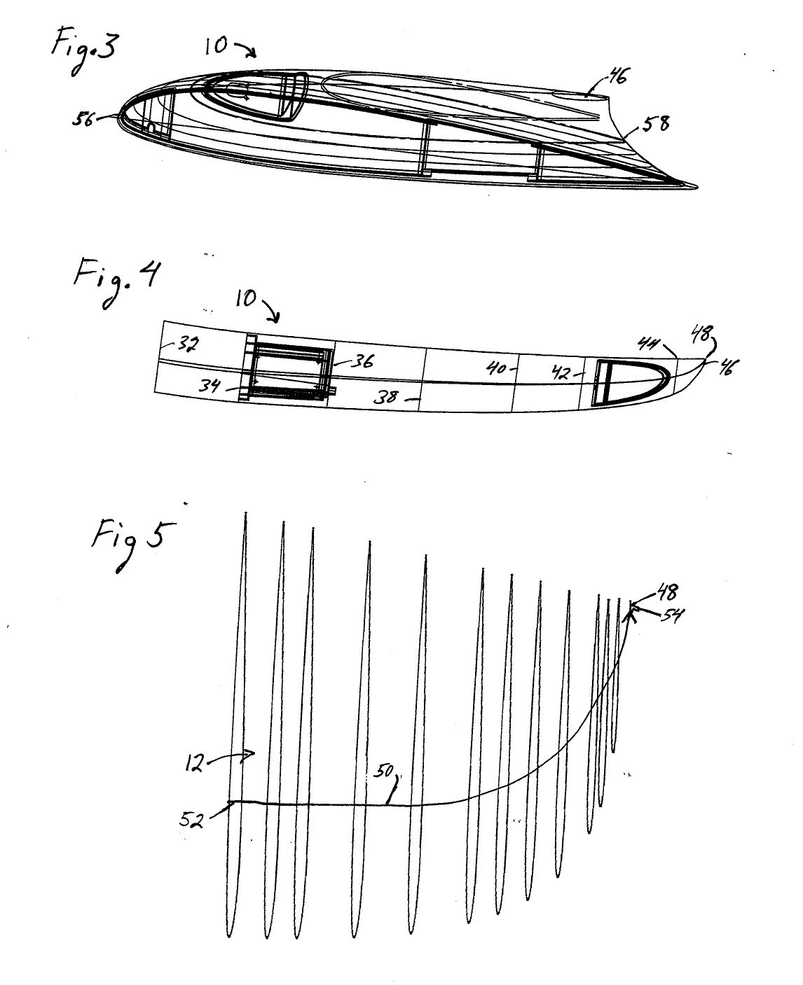

Now referring to the Figures, a preferred embodiment of a wingtip of the present invention is shown in FIGS. 1-4 and indicated generally by the numeral 10. It will be appreciated that both left and right wingtips are shown and that each is a mirror image of the other. Generally speaking, wingtip 10 has an aerodynamic shape having an inboard airfoil identical to the existing tip of a wing to be extended, i.e., NACA 23012, and a continuously changing airfoil shape to its tip functioning to direct the associated vortex generated by lift of the wing upward and outward from the tip.

Wingtip 10 comprises an inboard section 12 which has a hollow interior 14 which is sized and shaped to fit closely telescopically over outboard end 16 of an associated wing. Section 12 of wingtip 10 has an airfoil shape which is identical to the airfoil shape of outboard end 16 as well as the same angle of incidence. Wingtip 10 is particularly well adapted for installation on Bonanza aircraft which have a NACA airfoil 23012.

The outward side of section 12 has rib 18 with recessed portion 24 for accommodation of a flux sensor (not shown) or other desired apparatus. Forward of recessed portion 24 and located in the leading edge of wingtip 10 is another recess 26 for locating a landing light (not shown). Outward from recess 26 and also in the leading-edge of wingtip 10 is another recess 28 for locating navigation and strobe lights (not shown). A fuel tank bay 30 holds about 15 gallons of fuel. An internal antenna 31 can be bonded into the skin of the wingtip.

The aerodynamic shape of wingtip 10 functions to provide additional lift to the associated wing while reducing overall induced drag. Airfoil sections 32, 34, 36, 38, 40, 42, 44, and 46 are shown for explanatory purposes in FIGS. 1-5. Airfoil sections are all perpendicular to the lateral axis of the associated aircraft. The airfoil sections continuously decrease in size from section 12 to outboard tip 48. The airfoil sections also continuously trend toward being symmetrical with the outermost airfoil section at tip 48 being symmetrical. It will be appreciated by those skilled in the art that tip 48 does not generate lift but in accordance with the present design does contribute to the pressure pattern of wingtip 10. As illustrated in FIG. 5, airfoil sections of wingtip 10 are arranged so that the points of lowest pressure of each section are along a line 50 which curves from point 52 outward to point 54 at tip 48.

Leading-edge 56 of wingtip 10 is swept back towards tip 48 while trailing edge 58 is not swept back. As best shown in FIG. 4 wingtip 10 is swept slightly upwardly towards tip 48 which upward sweep provides additional dihedral to the associated wing.

The present invention provides many advantages to an aircraft. The wingtip decreases overall drag of the wing by reducing induced drag while only slightly increasing form drag. On a Bonanza aircraft wingtip 10 adds approximately 11 ft.² of total wing area and provides additional lift to improve climb rate due to lower wing loading. The additional dihedral provided by wingtip 10 lowers the spiraling moment of the associated aircraft. Wingtip 10 holds approximately 15 gallons of fuel for a Bonanza aircraft thus providing longer-range due to increased fuel capacity. Longer-range is also obtained because the aircraft will obtain a higher true airspeed due to increased span efficiency, lower drag shape, as well as lower drag from use of flush antennas.

In operation, the pressure pattern of the wingtip provides a lowest pressure point all of the way to tip 48 thus directing the associated wingtip vortex ou, toward from wingtip 10 and upward. This functions to reduce induced drag associated with the creation of lift for the aircraft wing.

While a preferred embodiment of the present invention has been disclosed in the foregoing disclosure in the context of Bonanza aircraft, it will be appreciated by those skilled in the art that this invention is useful for other similar aircraft wing. It is intended that the present invention may be subject to variation and modification within the broad scope of the invention. Therefore, it will be appreciated by those skilled in the art that the present invention is intended to be limited only by the scope of the following claims.

What is claimed is:

1. A wingtip for extending a wing of an aircraft having a NACA 23012 airfoil, the wing tip has an airfoil design which directs an associated wingtip vortex outward and upward to thereby increase the effective wingspan of the aircraft to reduce induced drag
